(19) United States
(12) Patent Application Publication
(10) Pub. No.: US 2020/0317188 A1
(43) Pub. Date: Oct. 8, 2020

(54) SYSTEMS AND METHODS FOR MONITORING A VEHICLE DURING AUTO-PARKING

(71) Applicants: Denso International America, Inc., Southfield, MI (US); Denso Corporation, Kariya-city (JP)

(72) Inventors: Ting-Yu Lai, Ann Arbor, MI (US); Michael Corcoran, Lake Orion, MI (US)

(21) Appl. No.: 16/373,744

(22) Filed: Apr. 3, 2019

(51) Int. Cl. B60W 30/06; G06K 9/00; G08G 1/14

(52) U.S. Cl. CPC B60W 30/06; G06K 9/00798; G08G 1/144; G06K 9/00812; G06K 9/00805

(57) ABSTRACT

System, methods, and other embodiments described herein relate to improving auto-parking of a vehicle. In one embodiment, a method includes, in response to initiating auto-parking of the vehicle, defining a set of thresholds according to at least environmental characteristics of a surrounding environment of the vehicle. The method includes monitoring, while the vehicle is auto-parking, a vehicle state of the vehicle according to sensor data from at least one sensor of the vehicle. The sensor data includes observations about the vehicle and the surrounding environment of the vehicle. The method includes selectively executing a response function according to whether the vehicle state satisfies at least one threshold in the set of thresholds. The response function mitigates abnormalities encountered by the vehicle when auto-parking.

### TECHNICAL FIELD

The subject matter described herein relates in general to systems and methods for improving auto-parking of a vehicle and, more particularly, to monitoring a vehicle state when the vehicle is auto-parking to ensure proper operation.

### BACKGROUND

As autonomy in vehicles improves such that, for example, vehicles can operate with complete autonomy, the ability of such vehicles to perform various driving-related tasks without the presence of an operator also improves. For example, if a vehicle can navigate along a roadway without manual inputs from an operator and while avoiding obstacles, then the vehicle is generally also capable of navigating without the presence of the operator. Accordingly, tasks traditionally associated with driving a vehicle can be automated in order to improve an overall driving experience.

One such example of a task that may be automated is parking the vehicle. That is, because the vehicle can function without inputs from the operator, the vehicle can also park without the presence of the operator or automatically with the presence of the operator. Auto-parking improves the driving experience by, for example, avoiding time spent by an operator seeking out a parking space, avoiding longer walks from parking spaces in poor weather conditions, and so on. However, along with such functionality comes the potential for abuse, accidents, and other negative outcomes that may result when an operator is not present to take action. That is, generally, an autonomous vehicle can navigate and park but may do so, in certain circumstances, in a manner that is not ideal. For example, a vehicle may auto-park and not leave adequate spacing on a side for clearance with another parking space because of variations in aspects of the environment such as narrow spaces, weather conditions, and other such factors that influence operation of the vehicle.

Moreover, because the operator is not present, the operator may not be aware of where the vehicle is parked and conditions around the vehicle. Thus, the operator may be unaware of the vehicle parking in an undesirable area, occurrences of impacts with the vehicle, the vehicle becoming blocked into a parking space, and so on. As such, while auto-parking has many potential benefits, various conditions may arise that may lead to various difficulties as outlined.

### SUMMARY

In one embodiment, example systems and methods associated with improving auto-parking for a vehicle are disclosed. As previously noted, an autonomous vehicle may experience variations in performance when auto-parking in different environmental conditions. These variations may include spacing on either side of the vehicle when parking, issues in navigating to a parking location over various terrain, abnormalities after parking, and so on. However, restricting auto-parking functionality to only areas with parking spaces of a particular size, and to circumstances that are otherwise deemed optical can overly limit instances in which the functionality could otherwise be useful.

Therefore, in one embodiment, a parking system actively monitors the vehicle while auto-parking (i.e., during the parking process and when parked) according to dynamically defined thresholds in order to improve auto-parking overall. That is, for example, the parking system, in one approach, monitors the vehicle when auto-parking according to a set of thresholds. The parking system, in one embodiment, defines the set of thresholds by adapting values for operating characteristics of the vehicle as a function of environmental characteristics of the surrounding environment in which the vehicle is operating. Thus, in one aspect, the system considers environmental characteristics such as traffic, weather, contextual characteristics/attributes of a locality (e.g., attributes of a parking lot/garage), and other aspects that may influence how the vehicle performs the auto-parking.

The system can then, for example, iteratively update a vehicle state (e.g., speed, clearance distances, vibration levels, etc.) as the vehicle progresses with the auto-parking and determine whether the vehicle state satisfies any one or more of the defined thresholds in the set. Accordingly, depending on the threshold that is satisfied, the system, in one approach, executes a response function to mitigate the conditions associated with the vehicle state satisfying the threshold. In one embodiment, the system executes the response function to, for example, adjust clearances/distances on either side of the vehicle in relation to parking space boundaries, obstacles, and so on. In further embodiments, the system may execute the response function to, for example, communicate an alert to inform an operator about the vehicle state. In this way, the parking system provides for improving circumstances in which the auto-parking functionality can be employed.

In one embodiment, a parking system for improving auto-parking in a vehicle is disclosed. The parking system includes one or more processors and a memory that is communicably coupled to the one or more processors. The memory stores a monitoring module including instructions that when executed by the one or more processors cause the one or more processors to, in response to initiating auto-parking of the vehicle, define a set of thresholds according to at least environmental characteristics of a surrounding environment of the vehicle. The monitoring module includes instructions to monitor, while the vehicle is auto-parking, a vehicle state of the vehicle according to sensor data from at least one sensor of the vehicle. The sensor data includes observations about the vehicle and the surrounding environment of the vehicle. The memory stores a response module including instructions that when executed by the one or more processors cause the one or more processors to selectively execute a response function according to whether the vehicle state satisfies at least one threshold in the set of thresholds, wherein the response function mitigates abnormalities encountered by the vehicle when auto-parking.

In one embodiment, a non-transitory computer-readable medium is disclosed. The computer-readable medium stores instructions that when executed by one or more processors cause the one or more processors to perform the disclosed functions. The instructions include instructions to, in response to initiating auto-parking of the vehicle: define a set of thresholds according to at least environmental characteristics of a surrounding environment of the vehicle. The instructions include instructions to monitor, while the vehicle is auto-parking, a vehicle state of the vehicle according to sensor data from at least one sensor of the vehicle. The sensor data includes observations about the vehicle and the surrounding environment of the vehicle. The instructions include instructions to selectively execute a response function according to whether the vehicle state satisfies at least one threshold in the set of thresholds. The response function mitigates abnormalities encountered by the vehicle when auto-parking.

In one embodiment, a method of improving auto-parking of a vehicle is disclosed. In one embodiment, a method includes, in response to initiating auto-parking of the vehicle, defining a set of thresholds according to at least environmental characteristics of a surrounding environment of the vehicle. The method includes monitoring, while the vehicle is auto-parking, a vehicle state of the vehicle according to sensor data from at least one sensor of the vehicle. The sensor data includes observations about the vehicle and the surrounding environment of the vehicle. The method includes selectively executing a response function according to whether the vehicle state satisfies at least one threshold in the set of thresholds. The response function mitigates abnormalities encountered by the vehicle when auto-parking.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a configuration of a vehicle in which example systems and methods disclosed herein may operate.

FIG. 2 illustrates one embodiment of a parking system that is associated with improving auto-parking a vehicle.

FIG. 3 illustrates one embodiment of a method associated with monitoring a vehicle during auto-parking.

FIG. 4 illustrates one embodiment of a method associated with monitoring a vehicle that has been parked using auto-parking functionality.

FIG. 5 is a diagram depicting thresholds associated with auto-parking a vehicle.

FIG. 6 is another diagram depicting thresholds associated with controlling a vehicle to auto-park.

### DETAILED DESCRIPTION

Systems, methods, and other embodiments associated with improving the auto-parking of a vehicle are disclosed. As previously noted, an autonomous vehicle may experience variations in performance when auto-parking in different environmental conditions. These variations may include issues arising out of environmental characteristics such as weather (e.g., snow/ice, etc.), abnormalities while parked (e.g., vibrations on vehicle), contextual characteristics of a location (e.g., parking space width), and so on. However, restricting auto-parking functionality to only areas with parking spaces of a particular size, and to circumstances that are otherwise deemed optimal (e.g., bright sunny days without any traffic) can overly limit instances in which the functionality could otherwise be useful.

Therefore, in one embodiment, a parking system dynamically defines thresholds relating to operating characteristics of a vehicle in order to improve auto-parking overall. The disclosed parking system, in one approach, monitors a vehicle state (e.g., operating characteristics such as speed, clearances, etc.) of the vehicle when auto-parking according to the set of thresholds. The parking system can define the set of thresholds dynamically by adapting values for operating characteristics of the vehicle as a function of environmental characteristics of the surrounding environment in which the vehicle is operating. Thus, in one aspect, the system considers environmental characteristics such as traffic, weather, contextual characteristics/attributes of a locality (e.g., attributes of a parking lot/garage), and other aspects that may influence how the vehicle performs the auto-parking and defines values of various thresholds in the set according thereto to, for example, provide points of reference against various operating characteristics of the vehicle such as clearances, speeds, levels of vibration on the vehicle, and so on. By way of example, the thresholds may define reduced speeds when the weather is snowy/icy, reduced clearances when parking spaces are narrow to permit a vehicle to park in the narrow spots, increased levels of vibration when parking on a trailer, and so on.

The system can then, for example, iteratively update a vehicle state (e.g., speed, clearance distances, vibration levels, etc.) as the vehicle progresses with the auto-parking and determine whether the vehicle state satisfies (e.g., exceeds, equals, etc.) any one or more of the defined thresholds in the set. Accordingly, depending on the threshold that is satisfied, the system, in one approach, executes a response function to mitigate the conditions associated with the vehicle state satisfying the threshold. For example, in a circumstance where the vehicle parks within a threshold of a boundary marker of a parking space, in one embodiment, the system executes the response function to adjust a position of the vehicle within the spot so that clearances/distances on either side of the vehicle are not less than the defined threshold. As a further example, in one embodiment, the system may execute the response function to, for example, communicate an alert to inform an operator about the vehicle state when vibration levels exceed levels defined by a threshold. In this way, the system improves auto-parking in the vehicle by dynamically adapting the thresholds and selectively executing various response functions to correct operation of the vehicle.

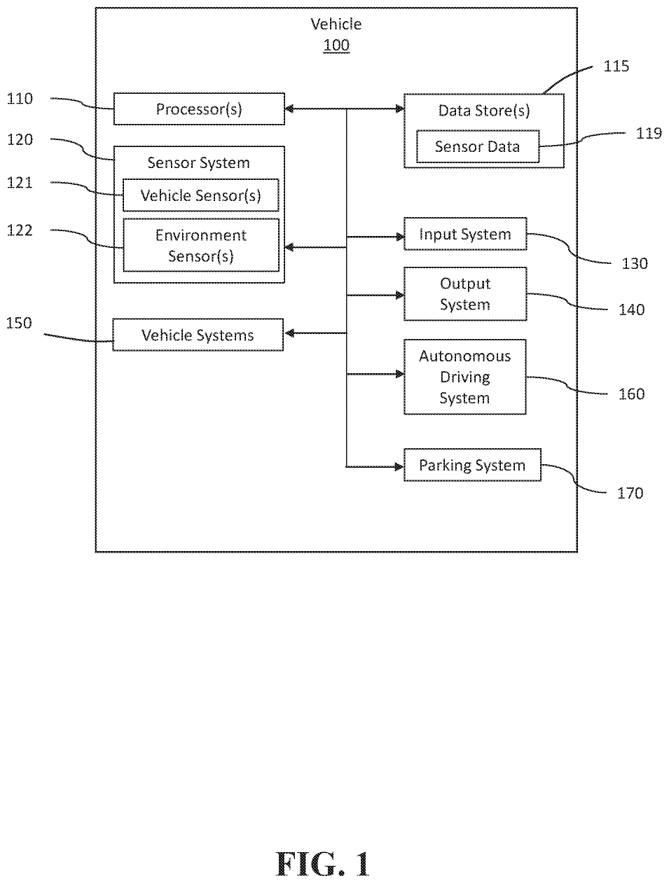

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, can operate autonomously to perform auto-parking and thus benefits from the functionality discussed herein.

The vehicle 100 also includes various elements. It will be understood that in various embodiments the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

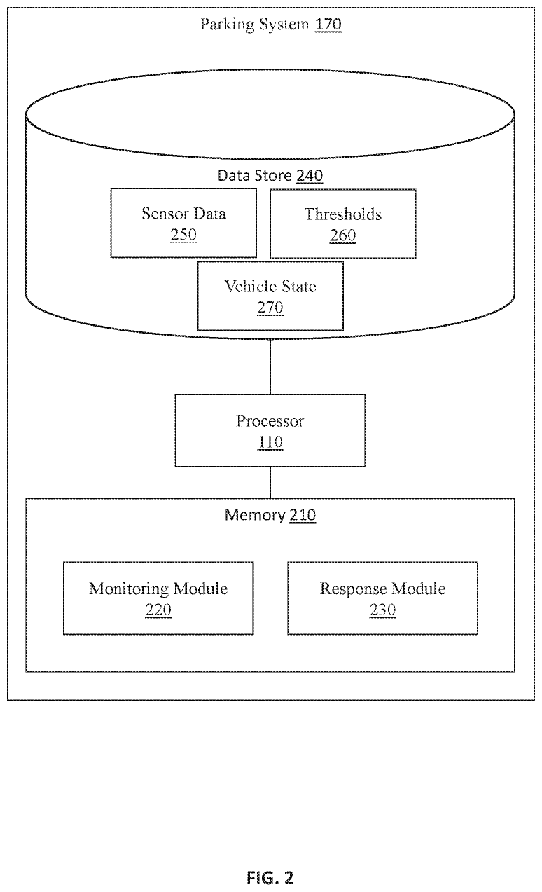

Some of the possible elements of the vehicle 100 are shown in FIG. 1 and will be described along with subsequent figures. A description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In either case, the vehicle 100 includes a parking system 170 that functions to improve how the vehicle adapts to various environmental circumstances when auto-parking (i.e., during the process of auto-parking and while parked). Moreover, while depicted as a standalone component, in one or more embodiments, the parking system 170 is integrated with the autonomous driving system 160, or another component of the vehicle 100. The noted functions and methods will become more apparent with a further discussion of the figures.

With reference to FIG. 2, one embodiment of the parking system 170 is further illustrated. As shown, the parking system 170 includes a processor 110. Accordingly, the processor 110 may be a part of the parking system 170 or the parking system 170 may access the processor 110 through a data bus or another communication path. In one or more embodiments, the processor 110 is an application specific integrated circuit that is configured to implement functions associated with a monitoring module 220 and a response module 230. In general, the processor 110 is an electronic processor such as a microprocessor that is capable of performing various functions as described herein. In one embodiment, the parking system 170 includes a memory 210 that stores the monitoring module 220 and the response module 230. The memory 210 is a random-access memory (RAM), read-only memory (ROM), a hard disk drive, a flash memory, or other suitable memory for storing the modules 220 and 230. The modules 220 and 230 are, for example, computer-readable instructions that when executed by the processor 110 cause the processor 110 to perform the various functions disclosed herein. While, in one or more embodiments, the modules 220 and 230 are instructions embodied in the memory 210, in further aspects, the modules 220 and 230 include hardware such as processing components (e.g., controllers) for independently performing the noted functions.

Furthermore, in one embodiment, the parking system 170 includes a data store 240. The data store 240 is, in one embodiment, an electronically-based data structure for storing information. For example, in one approach, the data store 240 is a database that is stored in the memory 210 or another suitable medium, and that is configured with routines that can be executed by the processor 110 for analyzing stored data, providing stored data, organizing stored data, and so on. In either case, in one embodiment, the data store 240 stores data used by the modules 220 and 230 in executing various functions. In one embodiment, the data store 240 includes sensor data 250, thresholds 260, and a vehicle state 270 along with, for example, other information that is used by the modules 220 and 230.

Accordingly, the monitoring module 220 generally includes instructions that function to control the processor 110 to acquire data inputs from one or more sensors (e.g., sensor system 120) of the vehicle 100 that form the sensor data 250. In general, the sensor data 250 includes information that embodies observations of a surrounding environment of the vehicle 100, and, in one embodiment, observations about the vehicle 100 itself. Thus, the observations embodied in the sensor data 250 can include observations of, for example, surrounding lanes (e.g., location and spacing), vehicles/obstacles that may be present in the lanes, obstacles (e.g., barriers along a roadway, traffic cones, gates, etc.), parking space markers, weather, road surface conditions, traffic levels, pedestrians, nearby parking structures, nearby businesses, and other information that identifies environmental characteristics both physical and contextual about a location of the vehicle 100.

Furthermore, the sensor data 250, in one embodiment, includes information about operating characteristics of the vehicle 100 that generally define the vehicle state 270 at separate instances in time. The operating characteristics, as used herein, refer to attributes of the vehicle 100 as experienced during operation when, for example, navigating to and parking in a parking space. Thus, in one embodiment, the operating characteristics include attributes relating to the vehicle 100 such as speed, vibrations (e.g., road vibrations from uneven surfaces, vibrations from surrounding impacts/noises, etc.), pitch angle associated with driving/parking on a gradient, distances/clearances between the vehicle 100 and obstacles, distances/clearances between the vehicle and markers (e.g., lane markers, space markers, etc.), lateral forces, and other aspects relating to operation of the vehicle 100.

Thus, the sensor data 250 generally includes observations about many different aspects relating to the vehicle 100 and the surrounding environment in which the vehicle 100 operates. As such, the monitoring module 220 can employ various individual sensors and/or combinations of sensors from the vehicle 100 to acquire the sensor data 250. Thus, the sensor data 250 can include GPS data about a location and, in one aspect, referenced against metadata of a map, data from V2X communications with an electronic parking administrator of a parking lot, images from one or more cameras, point clouds, radar scans, and so on. Accordingly, the parking system 170 may be implemented to use multiple sensors of the sensor system 120 including, for example, interior and/or exterior sensing sensors such as cameras in various combinations (e.g., visible light, infrared, stereo, etc.), LiDAR sensors in combination with one or more cameras, different types of LiDARs and cameras, communication devices for vehicle-to-vehicle (v2v) and/or vehicle-to-anything (V2X) communications, integrated sensors (e.g., IMU, wheel sensors, etc.), and so on.

Moreover, as a general matter, the monitoring module 220, in one approach, acquires the sensor data 250 and processes the sensor data 250 to generate the vehicle state 270 and determinations about the surrounding environment. In alternative arrangements, the monitoring module 220 functions cooperatively with other modules/systems in the vehicle 100 to acquire and/or analyze the sensor data 250. For example, the monitoring module 220, in one approach, functions together with the autonomous driving system 160 to implement various routines for performing object detection and recognition, localization, lane marker/boundary identification, and so on. Thus, the autonomous driving system 160 and the monitoring module 220, in one embodiment, use the sensor data 250 to identify aspects of the surrounding environment and/or the operating characteristics of the vehicle 100. Of course, in various arrangements, the monitoring module 220 independently implements the noted functionality.

In either case, the monitoring module 220, in one embodiment, controls the respective sensors to provide the data inputs in the form of the sensor data 250. Additionally, while the monitoring module 220 is discussed as controlling the various sensors of the sensor system 120 to provide the sensor data 250, in one or more embodiments, the monitoring module 220 employs other techniques that are either active or passive to acquire the sensor data 250. The monitoring module 220 may passively sniff the sensor data 250 from a stream of electronic information provided by the various sensors to further components within the vehicle 100. Moreover, the monitoring module 220 can undertake various approaches to fuse data from multiple sensors and/or from sensor data acquired over a wireless communication link (e.g., v2v, WiFi, etc.) from one or more surrounding vehicles and/or wirelessly enabled sensors/devices. Thus, the sensor data 250, in one embodiment, represents a combination of measurements acquired from multiple sources.

Moreover, with further reference to FIG. 2, in one embodiment, the monitoring module 220 generally includes instructions that function to control the processor 110 to analyze the sensor data 250 and determine environmental characteristics of the surrounding environment. As a preliminary matter, this discussion generally focuses on circumstances involving auto-parking (i.e., autonomous navigation to and parking in a parking space) of the vehicle 100. Thus, as a preliminary determination, the monitoring module 220, in one embodiment, determines whether a request to perform auto-parking has been received. Accordingly, the monitoring module 220, in one approach, monitors the autonomous driving system 160 for a change in state or a presence of a signal that indicates auto-parking is to be performed. Alternatively, in another approach, the monitoring module 220 monitors for an electronic signal from the autonomous driving system 160 or another system in the vehicle 100 to indicate auto-parking is to occur. In either case, the monitoring module 220 determines when the auto-parking is initiating and performs further determinations therefrom.

In one embodiment, the monitoring module 220 determines the environmental characteristics at the time of initiation of the auto-parking from which the monitoring module 220 proceeds to define the thresholds 260. Alternatively, or additionally, the monitoring module 220, in one embodiment, dynamically determines the environmental characteristics in an ongoing manner through the auto-parking, and thus may further update the thresholds 260 according to changes in the environmental characteristics during the auto-parking. In either case, the monitoring module 220 analyzes the sensor data 250 to derive the environmental characteristics and determine therefrom aspects that influence how the vehicle 100 operates during auto-parking.

In one approach, the monitoring module 220 uses defined policies to identify aspects of the surrounding environment from the environmental characteristics that affect the operation of the vehicle 100. In further aspects, the monitoring module 220 implements machine learning algorithms or heuristics to assess the environmental characteristics. Whichever approach is undertaken, the monitoring module 220 uses the environmental characteristics derived from the sensor data 250 to define the thresholds 260. The thresholds 260, in one embodiment, define values, ranges of values, set of conditions, or other factors associated with the operation of the vehicle 100. Thus, the thresholds 260 generally correspond to one or more of the operating characteristics of the vehicle 100.

For example, to define the thresholds 260, the monitoring module 220, in one approach, associates different aspects of the environmental characteristics with different operating characteristics of the vehicle 100. Depending on values or conditions of the different aspects, the monitoring module 220 adjusts the values of the operating characteristics and defines the thresholds 260 according to the values that are, for example, appropriate for the associated conditions.

By way of example, the monitoring module 220 produces the environmental characteristics to indicate, in one aspect, road conditions such as dry, wet, icy, snow-covered, etc. According to this condition, the monitoring module 220 defines a threshold for an operating characteristic such as speed according thereto (e.g., progressively lowers speeds according to road surface conditions). In further aspects, the monitoring module 220 considers multiple aspects of the environmental conditions when defining a given one of the thresholds 260. Continuing with the prior example, the monitoring module 220 may further consider geometries of the road along which the vehicle 100 is to travel (e.g., how curvy, how narrow, etc.), a physical condition of the road (e.g., the presence of potholes/bumps, road surface type, etc.), a level of traffic (e.g., no congestion up to completely congested), and so on. As such, the monitoring module 220 can further refine the threshold according to the additional aspects.

As a further example, the monitoring module 220, in one embodiment, considers contextual characteristics of the surrounding environment as part of the environmental characteristics. The contextual characteristics include, for example, attributes of at least a current location of the vehicle 100 such as rules associated with driving/parking, parking fees, proximity to various businesses or services, attributes of facilities (e.g., parking facilities), and so on. Thus, as one example, the contextual characteristics may indicate the attributes of a parking facility including dimensions of parking spaces, the presence of speed bumps/tables, widths of aisles, and soon. As such, the monitoring module 220 can define various ones of the thresholds 260 according to the attributes. For example, the monitoring module 220 may use the parking space dimensions to define clearance distances on either side of the vehicle 100 between the vehicle 100 and defined boundaries of the parking space. In further aspects, the monitoring module 220 defines a threshold for speed when driving within the parking facility according to the identified attributes of the parking facility (e.g., aisle width, the presence of speed tables, etc.).

As an additional aspect, in one embodiment, the monitoring module 220 considers the environmental aspects in relation to attributes of the vehicle 100. That is, the monitoring module 220 considers dimensions of the vehicle 100, maneuverability of the vehicle 100 (e.g., turn radius), acceleration, braking, traction/tires, and other attributes. As such, the monitoring module 220 considers the attributes when defining the thresholds in order to accurately define the thresholds to account for the attributes. For example, when the monitoring module 220 determines clearances for the vehicle 100 when parking in a space of a particular dimension, the monitoring module 220 considers a width of the vehicle 100 in comparison to a width of the parking space, and defines the associated threshold with consideration to the relative widths. In a further example, the monitoring module 220 considers braking ability and traction in relation to road conditions (e.g., dry vs. wet vs. icy) to define appropriate speed values for the thresholds 260.

As such, the monitoring module 220 actively defines the thresholds 260 according to the environmental characteristics in order to, for example, customize the operation of the vehicle 100 when auto-parking according to the surrounding environment. As previously mentioned, the monitoring module 220 may assess the environmental conditions and define the thresholds 260 upon initiating auto-parking and/or dynamically update the thresholds 260 according to the environmental conditions throughout the auto-parking process.

In either case, the monitoring module 220 further monitors the vehicle state 270 in relation to the thresholds 260. That is, as the vehicle 100 progresses with auto-parking, the monitoring module 220 acquires the sensor data 250 including information relating to the operating characteristics of the vehicle 100. From the sensor data 250, the monitoring module 220, in one approach, iteratively updates the vehicle state 270 at successive instances in time. In various approaches, the monitoring module 220 may update the vehicle state 270 according to a sampling rate for the sensor data 250, according to regularly defined intervals, or according to another approach. However, the monitoring module 220, in either instance, updates the vehicle state 270 to provide updated points of comparison for determining whether the vehicle 100 is operating within the thresholds 260. Thus, the monitoring module 220 updates the vehicle state 270 to identify clearances, speeds, vibration levels, and other operating characteristics as the vehicle 100 progresses along a path.

With continued reference to FIG. 2, in one embodiment, the response module 230 generally includes instructions that function to control the processor 110 to selectively execute a response function according to the thresholds 260. That is, as the vehicle 100 progresses along a path when auto-parking or while parked, the response module 230 is comparing the thresholds 260 with the vehicle state 270 at, for example, successive updates of the vehicle state 270. In general, the response module 230 is determining whether the operation of the vehicle 100 is within the bounds defined by the thresholds 260 to ensure that the vehicle 100 conforms with specified values for the operating characteristics according to the environmental characteristics.

As such, in one approach, the response module 230 is iteratively comparing the vehicle state 270 with the thresholds 260 to determine whether the vehicle state 270 satisfies one or more of the thresholds 260. That is, while the vehicle 100 is auto-parking (i.e., while navigating to/from, parking in, or parked in a parking space), the response module 230 is comparing the vehicle state 270 as dynamically determined by the monitoring module 220 at successive points in time with the thresholds 260. Thus, the response module 230 is determining at least semi-continuously as the vehicle 100 progresses with auto-parking whether the vehicle 100 is operating within the defined thresholds 260 and thus whether the vehicle 100 is operating, for example, appropriately for the environmental characteristics.

In determining whether the vehicle state 270 satisfies the threshold(s) 260, the response module 230 may implement various approaches depending on, for example, attributes of the threshold(s) 260. That is, in one approach, the response module 230 determines that a threshold is satisfied according to whether a corresponding value from the vehicle state 270 exceeds (e.g., is greater than) the threshold. For example, the response module 230 may compare a current speed of the vehicle 100 with a threshold speed for the roadway under the present conditions. In further examples, the response module 230 determines that the threshold is satisfied according to whether a corresponding value from the vehicle state 270 does not exceed a threshold. For example, when the threshold defines a minimum distance for clearance between the vehicle 100 and an obstacle or defined boundary of a parking space, the value of the clearance as indicated by the vehicle state 270 should be greater than the threshold and if not, then the response module 230 determines the threshold to be satisfied.

In a still further embodiment, the response module 230 determines whether a threshold is satisfied according to a discrete determination such as the presence of a condition or not. As one example, the thresholds 260 may define conditions for a parking space such as covered or not. Thus, the response module 230 may indicate that the threshold is satisfied when the condition is not present (e.g., uncovered when required to be covered). Of course, while the thresholds 260 are generally discussed with relative terms defining inequalities or other relationships, the thresholds 260 can generally be defined according to other criteria as may be desired.

Moreover, in one approach, the response module 230 implements a policy or set of rules that indicate a combination (e.g., two or more) of the thresholds 260 are to be satisfied to satisfy the thresholds 260. In either case, the response module 230 selectively executes one or more response functions according to whether the vehicle state 270 satisfies one or more of the thresholds 260. Thus, the response module 230 generally executes the response functions to mitigate abnormalities encountered by the vehicle 100 during auto-parking. That is, as the vehicle 100 encounters abnormalities associated with the vehicle state 270 satisfying one or more of the thresholds 260, the response module 230 can execute one or more response functions to cause the vehicle 100 to adjust various aspects of the vehicle state 270 and/or to provide information to an operator.

For example, in one approach, the response module 230 selects a response function from a group of functions according to which threshold or combination of the thresholds 260 are satisfied. Moreover, in one approach, the response module 230 selects and executes multiple response functions depending on the particular threshold(s) that violated. In general, the response module 230 selects the response function according to aspects of the vehicle state 270 that are, for example, out of bounds and, in one approach, in consideration of the environmental characteristics.

Thus, by way of example, in one approach, the response module 230 may execute a response function to brake the vehicle 100 when a speed is excessive. In further aspects, the response module 230 further considers environmental characteristics such as road condition, and thus may execute a response function to limit speed instead of braking when, for example, the road is slippery from ice. As further examples, the response module 230, in one embodiment, executes a response function to adjust a clearance between the vehicle 100 and a defined boundary. The defined boundary may be a marker for a parking space, a lane, an entry into a parking facility, and so on. Thus, the response module 230 executes the response function to adjust the clearance distance by, for example, controlling the vehicle 100 to increase the clearance. In the instance of a parking space, the response module 230 controls the vehicle 100 either directly or through a command communicated to the system 160 to cause the vehicle to pull out of the parking space and re-park according to the clearance defined by an associated threshold.

In further aspects, for example, when the vehicle 100 is parked, the response module 230 may execute a response function to electronically communicate the vehicle state 270 to an electronic device associated with an operator of the vehicle 100. For example, when defined levels for vibrations on the vehicle 100 are satisfied, the response module 230 communicates the state 270, and/or other information about the vehicle 100 (e.g., images from cameras integrated with the vehicle 100) to the operator. The thresholds 260 may define vibration levels according to a location in which the vehicle 100 is parked, such as a parking facility, a trailer, a cargo carrier, street-side, and so on. The vibration levels generally indicate an acceptable/expected level of activity around the vehicle 100 beyond which abnormal conditions are considered to be likely occurring. In either case, the response module 230 can execute a response function to generate and provide communications to an electronic device of the operator as a further example of responses that the response module 230 may undertake.

Moreover, as previously mentioned, the response module 230 may undertake multiple separate response functions when, for example, a particular combination of the thresholds 260 are satisfied. As one example, the response module 230, in response to the vehicle state 270 satisfying a threshold for speed and a threshold for vibration levels, executes a response function to limit the speed and an additional response function to provide a communication to the operator. In further aspects, the particular combination of response functions may differ; however, it should be appreciated that the parking system 170 provides a robust mechanism for monitoring the vehicle 100 and defining a range of responses to mitigate abnormalities. In this way, the parking system 170 improves the process of auto-parking by permitting an adaptable approach to automatically monitor the vehicle 100 and respond to arising circumstances during auto-parking.

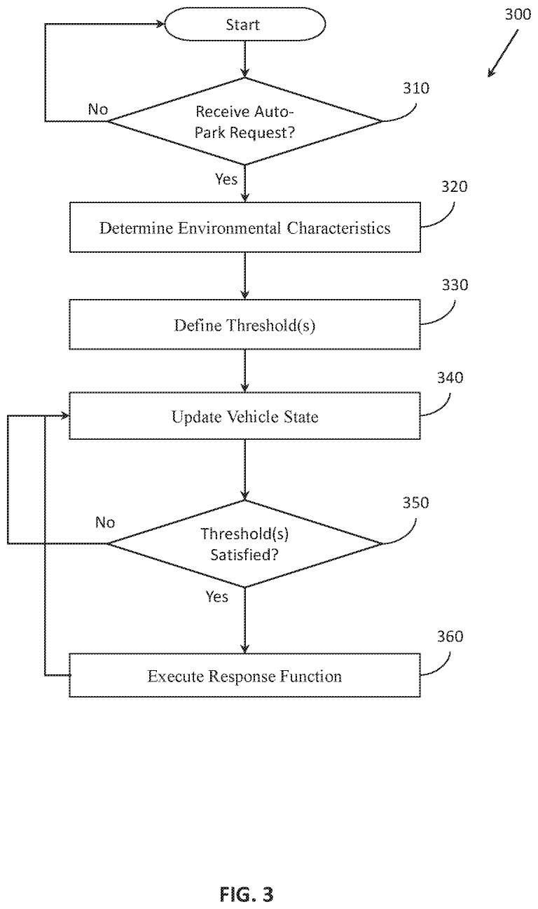

Additional aspects of monitoring a vehicle during the process of auto-parking will be discussed in relation to FIG. 3. FIG. 3 illustrates a method 300 associated with improving auto-parking functionality of a vehicle by providing dynamic real-time monitoring of an auto-parking process. Method 300 will be discussed from the perspective of the parking system 170 of FIG. 1. While method 300 is discussed in combination with the parking system 170, it should be appreciated that the method 300 is not limited to being implemented within the parking system 170 but is instead one example of a system that may implement the method 300.

At 310, the monitoring module 220 monitors for a request to auto-park the vehicle 100. The request is, for example, communicated to the monitoring module 220 over a vehicle bus (e.g., CAN bus) or another communication medium (e.g., wirelessly). In one embodiment, the request is generated by, for example, a component of the vehicle 100 such as a process executing on a controller associated with a user interface (e.g., infotainment display, an integrated button). In further examples, the request is generated by and communicated from a personal device of an owner/operator such as an application executing on a mobile phone. In either case, the monitoring module 220 monitors for such a request and upon receiving the request induces the parking system 170 to execute further functions in support of monitoring the auto-parking. Moreover, while the monitoring module 220 is discussed as receiving the request, in one embodiment, the monitoring module 220 receives an indicator about the request from another system (e.g., system 160) in the vehicle 100 or identifies the occurrence of the request through monitoring a register, data structure, or other electronic indicator within the vehicle 100 for information identifying the occurrence of the request.

At 320, the monitoring module 220 determines environmental characteristics of the surrounding environment of the vehicle 100. In one embodiment, the monitoring module 220 acquires the sensor data 250 from which the monitoring module 220 can derive the environmental characteristics. Thus, the monitoring module 220 acquires, in one embodiment, observations of the surrounding environment that are both contextual conditions and physical conditions in order to generate the environmental characteristics associated with a location of the vehicle 100. Thus, the monitoring module 220 can leverage information from environmental sensors such as cameras, LiDAR, radar, etc. The monitoring module 220 can also acquire information from further sensors and information sources from which the contextual conditions can be derived. In one embodiment, the additional sensors and information sources include, for example, GPS, a communication network (e.g., the Internet), and so on.

Moreover, as the vehicle 100 is generally understood to be an autonomous or at least semi-autonomous vehicle that can autonomously park without the assistance of an operator, the vehicle 100 generally includes an array of sensors for perceiving the surrounding environment from which the monitoring module 220 can apply one or more machine perception techniques to derived the noted information. Additionally, the monitoring module 220 further derives metadata about the surrounding environment according to a location (e.g., GPS location), communication with nearby informational sources (e.g., parking administration system, V2X, etc.), and/or any other data that may be used by the monitoring module 220 to determine the environmental characteristics. In further aspects, the monitoring module 220 also acquires information about the vehicle 100 itself from onboard data stores and/or remote sources. In either case, the monitoring module 220 acquires the sensor data 250 and determines the environmental characteristics of the surrounding environment to identify at least traffic congestion, roadway conditions, and contextual conditions from which the thresholds 260 may be adjusted/defined.

At 330, the monitoring module 220 defines the thresholds 260. In one embodiment, the monitoring module 220 defines a set of thresholds (e.g., 1 to n thresholds) according to at least the environmental characteristics. Thus, in one approach, the monitoring module 220 generates the thresholds by, for example, determining which environmental characteristics correlate with separate operating characteristics of the vehicle 100. The monitoring module 220 can then adapt predefined thresholds for the operating characteristics or dynamically define the values for the operating characteristics according to the environmental characteristics in order to define the thresholds. This approach provides for defining boundaries on how the vehicle 100 operates specifically for the environmental characteristics of the location in which the vehicle 100 is auto-parking.

By way of example, in one embodiment, defining the threshold includes, in part, identifying regulations (e.g., speed limits, permitted parking zones, etc.) associated with a location of the vehicle 100. In various embodiments, the acquisition of the regulations and other contextual information may be undertaken by different components depending on a particular implementation. Thus, in one embodiment, the monitoring module 220 acquires the regulations as part of the environmental characteristics. The regulations may further define conditions such as acceptable locations (e.g., no parking on ramps), times, durations, required parking clearances, and so on. Thus, the monitoring module 220 uses this information to adjust the thresholds 260 for the current environment of the vehicle 100. As an additional note, while the determination of environmental characteristics at 320 and the definition of the thresholds at 330 by the monitoring module 220 are shown as discrete serial processes, in one embodiment, the monitoring module 220 performs the noted functions as a parallel process to dynamically update the environmental characteristics throughout the process of auto-parking and thus also update the thresholds 260 as conditions change during auto-parking.

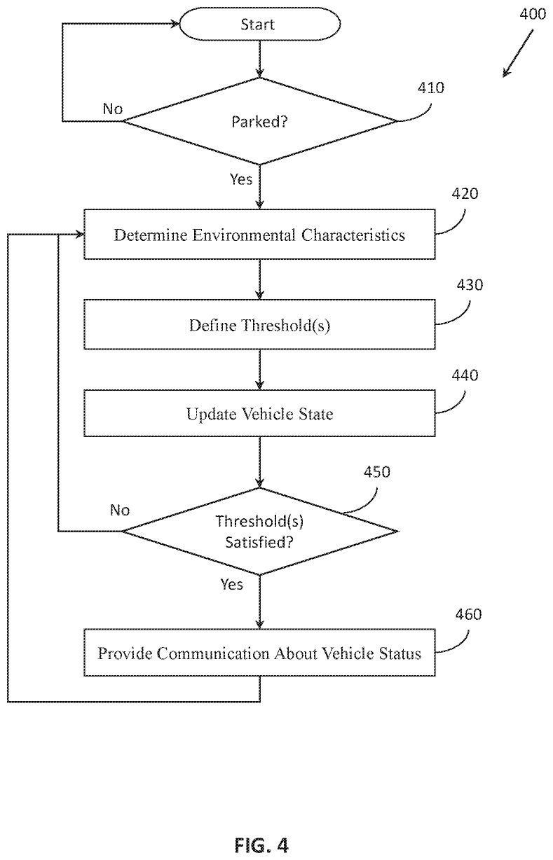

At 340, the monitoring module 220 updates the vehicle state 270. In one embodiment, the monitoring module 220 updates the vehicle state 270 at successive points in time in order to provide a current assessment of the operation of the vehicle 100. The vehicle state 270 itself generally includes, as previously described, current operating characteristics of the vehicle 100 and/or other information about how the vehicle 100 is progressing with auto-parking. In further examples, the monitoring module 220 also generates the vehicle state 270 to include information when the vehicle 100 is parked and, for example, waiting for a recall request as will be discussed in greater detail subsequently with FIG. 4. In either case, the monitoring module 220 generates the vehicle state 270 according to a current observed state/condition of the vehicle 100 and aspects encountered by the vehicle during auto-parking. In this way, the parking system 170 can monitor the vehicle 100 through tracking the vehicle state 270 at successive points in time and determining whether the vehicle state 270 remains within defined bounds as discussed at 350.

At 350, the response module 230 determines whether the vehicle state 270 satisfies one or more of the thresholds 260. As previously described, the particular attributes of the threshold being compared may define the conditions for determining satisfaction (e.g., less than, greater than, equals, etc.). Moreover, the response module 230 may define satisfaction as two or more thresholds being satisfied in combination. In either case, the response module 230 generally compares the vehicle state 270 with the thresholds 260 to determine whether the vehicle 100 is operating within constraints defined by the thresholds 260. By way of example, the response module 230, in one or more embodiments, compares a speed, distances between the vehicle 100 and markers/objects, pitch angles of the vehicle, levels of vibration experienced by the vehicle 100 and/or other aspects of the vehicle state 270 with the thresholds 260.

In this way, the parking system 170 can determine when abnormalities (e.g., excessive vibrations, insufficient clearances, etc.) occur when the vehicle 100 is auto-parking. Accordingly, if the response module 230 determines that the threshold(s) 260 have not been satisfied, then updating the vehicle state 270 and comparing with the thresholds 260 continues, as discussed at blocks 340 and 350. However, if the threshold(s) 260 are satisfied by the vehicle state 270, then the response module 230 continues to perform functions as discussed at block 360.

At 360, the response module 230 executes a response function selectively according to satisfaction of at least one threshold. In one embodiment, the response module 230 selects or at least identifies which response function to execute according to which threshold or combination of thresholds are satisfied. Thus, the response module 230 selects the response function as a response that corresponds with which value of the vehicle state 270 that is out of bounds and, in one embodiment, further according to the environmental characteristics. The response functions generally include functions to correct or otherwise cause the vehicle 100 to adjust operation in relation to the values of the vehicle state 270 that are abnormal according to the thresholds 260. Thus, the response functions can include adjusting operating limits, trajectories, position, and other aspects of the vehicle 100. In further aspects, the response functions can include simply logging or communicating information about the vehicle 100 to inform a remote agent (e.g., monitoring service, an operator/owner, etc.).

Additional aspects of monitoring a vehicle will be discussed in relation to FIG. 4. FIG. 4 illustrates a method 400 associated with improving auto-parking functionality of a vehicle by the vehicle 100 while parked. Method 400 will be discussed from the perspective of the parking system 170 of FIG. 1. While method 400 is discussed in combination with the parking system 170, it should be appreciated that the method 400 is not limited to being implemented within the parking system 170 but is instead one example of a system that may implement the method 400. Moreover, some aspects of the method 400 are similar to aspects of the method 300, and, thus, the various aspects may be discussed only briefly to avoid repetition of this discussion.

At 410, the monitoring module 220 determines whether the vehicle 100 is parked or is in the process of auto-parking. Thus, the parking system 170 may execute the method 400, or at least the determination at 410, in parallel with method 300. In any case, the monitoring module 220 generally determines that the vehicle 100 is parked by monitoring for a transmission of the vehicle 100 being shifted to a park setting, the vehicle 100 not moving for a defined amount of time, the vehicle 100 arriving at a location of an identified parking spot, and/or according to another metric. In either case, once the monitoring module 220 determines the vehicle 100 has parked, the monitoring module 220 proceeds with further determinations as discussed at block 420 and subsequently.

At 420, the monitoring module 220 determines environmental characteristics in a similar fashion as discussed at block 320 of FIG. 3. Moreover, the subsequent functions identified along with blocks 430, 440, and 450 are generally similar to functions discussed with blocks 330, 340, and 350, respectively. Of course, the noted functions may include aspects that are particular to the vehicle 100 being parked but are generally similar to the functions as previously described.

At 430, the monitoring module 220 defines the thresholds 260 according to the environmental characteristics. Thus, the monitoring module 220, at 430, may define the thresholds 260 according to relevant aspects for when the vehicle 100 is parked. Such as aspects may include levels of vibration, space for exiting a parking space (e.g., is the vehicle blocked-in by another vehicle or obstacle), and so on. The levels of vibration may be relative to a type of parking the vehicle 100 is undertaking. That is, the vehicle 100 may park on a trailer for transport, in a mechanical parking garage on a lift, in a multi-level parking garage, in a parking lot, on a street, and so on. As such, the different locations generally correspond with different expected levels of vibration. Moreover, the levels of vibration for the different locations may vary according to the environmental characteristics such as an extent of traffic, weather (e.g., wind), and so on. Therefore, the monitoring module 220 defines the thresholds 260 for when the vehicle 100 is parked according to aspects that relate to a location and conditions of the location.

At 440, the monitoring module 220 monitors the vehicle state 270. In one embodiment, the monitoring module 220, as discussed in relation to block 340, updates the vehicle state 270 at successive points in time. In this way, the monitoring module 220 can track the vehicle state 270 over time and in comparison to the thresholds 260.

At 450, the response module 230 determines whether the vehicle state 270 satisfies one or more of the thresholds 260. As discussed previously, the response module 230 compares the vehicle state 270 (e.g., vibration levels, determinations about clearances for egress from a parking space, etc.) to the thresholds 260. If the vehicle state 270 does not satisfy one or more of the thresholds 260, then the parking system 170 repeats the determinations and comparisons as specified. However, if the response module 230 determines that a threshold has been satisfied, then the response module 230 proceeds with executing a response function at 460.

At 460, the response module 230 executes a response function. In one embodiment, the response module 230, for example, electronically communicates the vehicle state 270 or aspects relating to the vehicle state 270 to an electronic device associated with an operator of the vehicle 100. In one embodiment, the response module 230 communicates images of surroundings of the vehicle 100, a condition that induces the response, or other relevant information. In a still further aspect, the response module 230 may generate an audible alarm or other alert within the proximity of the vehicle 100. The alarm/alert, in one example, is a voice communication requesting a second vehicle that is blocking the vehicle 100 within the parking space to move.

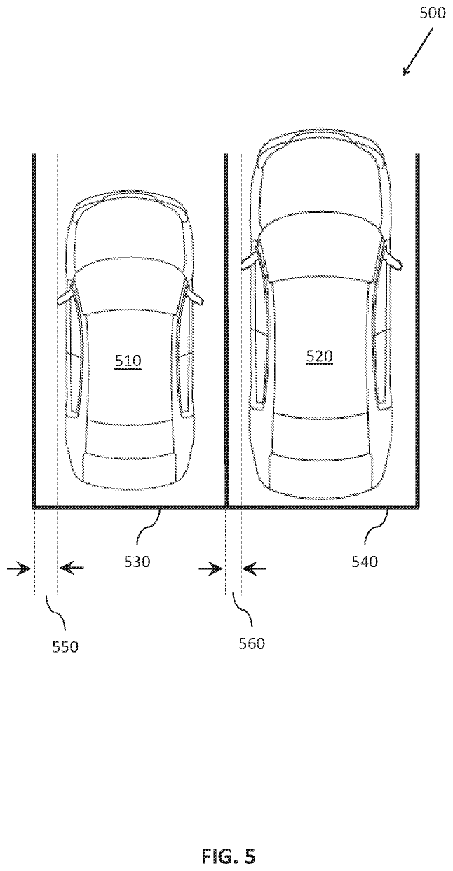

As further explanation of how the parking system 170 performs the noted functions, reference is now made to FIG. 5, which illustrates a diagram 500 of vehicles 510 and 520 parking in respective parking spaces 530 and 540. As shown, in FIG. 5, the comparative thresholds 550 and 560 vary according to a width of the respective vehicles 510 and 520. Moreover, the thresholds 550 and 560 may further vary according to a width of the parking spaces 530 and 540. In either case, in an instance where the vehicles 510 and 520 implement the parking system 170, the parking system 170 operates to monitor the thresholds 550 or 560 while the respective vehicle is parking. Should the vehicle not leave sufficient clearance to satisfy the threshold, then the parking system 170 causes the vehicle 100 to adjust a position with the parking space until achieving the proper clearance.

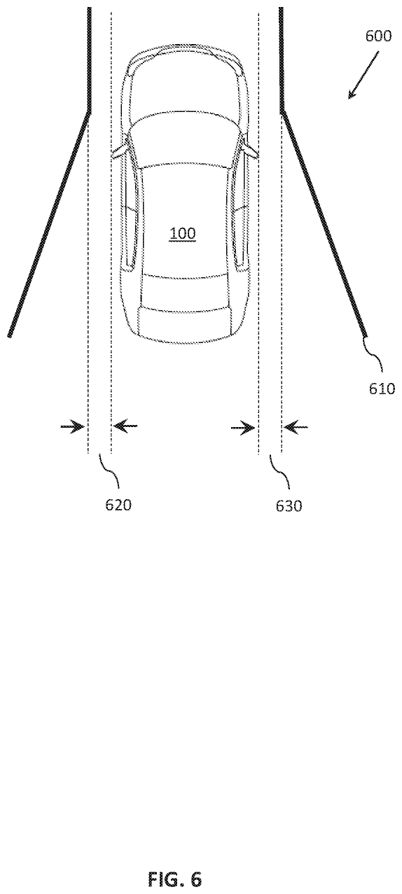

As a further example, consider FIG. 6, which illustrates a diagram 600 of a narrowing section of roadway with barriers 610 on either side of the roadway. As the vehicle 100 progresses through the barriers 610, the parking system 170 monitors the clearances 620 and 630 on either side to ensure that the clearances satisfy the thresholds 260. In one embodiment, the parking system may respond to inadequate clearances specified in the vehicle state 270 by slowing the vehicle 100 in which case the closer clearances may be acceptable. In this way, the parking system 170 monitors the vehicle 100 during the process of auto-parking to ensure proper operation.

Additionally, it should be appreciated that the parking system 170 from FIG. 1 can be configured in various arrangements with separate integrated circuits and/or chips. In such embodiments, the monitoring module 220 is embodied as a separate integrated circuit. Additionally, the response module 230 is embodied on an individual integrated circuit. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits. In another embodiment, the modules 220 and 230 may be combined into a separate application-specific integrated circuit. In further embodiments, portions of the functionality associated with the modules 220 and 230 may be embodied as firmware executable by a processor and stored in a non-transitory memory. In still further embodiments, the modules 220 and 230 are integrated as hardware components of the processor 110.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies (e.g., method 300 of FIG. 3) are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the parking system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 240) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level.

The one or more data stores 115 can include sensor data (e.g., sensor data 250). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment such as pressure/weight sensors in seats, seatbelt sensors, camera(s), and so on.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the parking system 170, and/or the autonomous driving system 160 can be operatively connected to communicate with the various vehicle systems 150 and/or individual components thereof. For example, returning to FIG. 1, the processor(s) 110 and/or the autonomous driving system 160 can be in communication to send and/or receive information from the various vehicle systems 150 to control the movement, speed, maneuvering, heading, direction, etc. of the vehicle 100. The processor(s) 110, the parking system 170, and/or the autonomous driving system 160 may control some or all of these vehicle systems 150 and, thus, may be partially or fully autonomous.

The processor(s) 110, the parking system 170, and/or the autonomous driving system 160 can be operatively connected to communicate with the various vehicle systems 150 and/or individual components thereof. For example, returning to FIG. 1, the processor(s) 110, the parking system 170, and/or the autonomous driving system 160 can be in communication to send and/or receive information from the various vehicle systems 150 to control the movement, speed, maneuvering, heading, direction, etc. of the vehicle 100. The processor(s) 110, the parking system 170, and/or the autonomous driving system 160 may control some or all of these vehicle systems 150.

The processor(s) 110, the parking system 170, and/or the autonomous driving system 160 may be operable to control the navigation and/or maneuvering of the vehicle 100 by controlling one or more of the vehicle systems 150 and/or components thereof. For instance, when operating in an autonomous mode, the processor(s) 110, the parking system 170, and/or the autonomous driving system 160 can control the direction and/or speed of the vehicle 100. The processor(s) 110, the parking system 170, and/or the autonomous driving system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the parking system 170 and/or the autonomous driving system 160 can function to perform various driving-related tasks such as parking the vehicle 100. That is, in one embodiment, the parking system 170, and/or the autonomous driving system 160 function to identify a suitable parking location and maneuver the vehicle 100 to the parking location/spot. In various approaches, this auto-parking functionality may further include communicating with one or more infrastructure devices (e.g., parking meters/systems) to pay fees, locate parking spots, and so on.

The vehicle 100 can include one or more actuators. The actuators can be any element or combination of elements operable to modify, adjust and/or alter one or more of the vehicle systems or components thereof responsive to receiving signals or other inputs from the processor(s) 110 and/or the autonomous driving system 160. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving systems 160. The autonomous driving system 160 can be configured to receive data from the sensor system 120 and/or any other type of system capable of capturing information relating to the vehicle 100 and/or the external environment of the vehicle 100. In one or more arrangements, the autonomous driving system 160 can use such data to generate one or more driving scene models. The autonomous driving system 160 can determine position and velocity of the vehicle 100. The autonomous driving system 160 can determine the location of obstacles, poses of obstacles, and/or other environmental features including traffic signs, trees, shrubs, neighboring vehicles, pedestrians, etc.

The autonomous driving system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving system 160 either independently or in combination with the parking system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250 as implemented by the system 170. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A parking system for improving auto-parking in a vehicle, comprising:
one or more processors;
a memory communicably coupled to the one or more processors and storing:
a monitoring module including instructions that when executed by the one or more processors cause the one or more processors to, in response to initiating auto-parking of the vehicle,
define a set of thresholds according to at least environmental characteristics of a surrounding environment of the vehicle, and
monitor, while the vehicle is auto-parking, a vehicle state of the vehicle according to sensor data from at least one sensor of the vehicle, wherein the sensor data includes observations about the vehicle and the surrounding environment of the vehicle; and
a response module including instructions that when executed by the one or more processors cause the one or more processors to selectively execute a response function according to whether the vehicle state satisfies at least one threshold in the set of thresholds, wherein the response function mitigates abnormalities encountered by the vehicle when auto-parking.

2. The parking system of claim 1, wherein the response module includes instructions to selectively execute the response function including instructions to i) select the response function from a group of responses according to the at least one threshold that the vehicle state satisfies, and ii) execute the response function when the vehicle state satisfies the at least one threshold to control at least one vehicle system to adjust the vehicle state in relation to the surrounding environment.

3. The parking system of claim 2, wherein the response module includes instructions to selectively execute the response function including instructions to control the vehicle to adjust a clearance distance between the vehicle and a defined boundary, and wherein the defined boundary includes one or more of an obstacle, a marker of a roadway, and a marker of a parking space.

4. The parking system of claim 1, wherein the response module includes instructions to selectively execute the response function including instructions to, in response to determining the vehicle is parked, execute the response function by electronically communicating the vehicle state to an electronic device associated with an operator of the vehicle.

5. The parking system of claim 1, wherein the monitoring module includes instructions to define the set of thresholds including instructions to acquire the environmental characteristics of the surrounding environment to identify at least traffic congestion, roadway conditions, and contextual conditions, and
wherein the contextual conditions indicate attributes of at least a current location of the vehicle including aspects associated with a parking facility.

6. The parking system of claim 5, wherein the monitoring module includes instructions to define the set of thresholds including instructions to adapt values for operating characteristics of the vehicle as a function of the environmental characteristics, and
wherein the monitoring module includes instructions to acquire the environmental characteristics including instructions to collect the sensor data and analyzing the sensor data to produce the environmental characteristics in relation to the operating characteristics, and
wherein the operating characteristics include one or more of parking distances, operating distances, speeds, and acceptable vibrations.

7. The parking system of claim 1, wherein the monitoring module includes instructions to monitor the vehicle state including instructions to iteratively update the vehicle state by analyzing the sensor data to determine values of operating characteristics for the vehicle, the operating characteristics corresponding with separate thresholds of the set of thresholds, and
wherein the vehicle state defines the values of the operating characteristics for a current time.

8. The parking system of claim 1, wherein the monitoring module includes instructions to identify the initiating of auto-parking of the vehicle by detecting a command to begin auto-parking, and
wherein the vehicle is capable of at least semi-autonomous operation and executes auto-parking by autonomously navigating and parking without intervention by an operator of the vehicle.

9. A non-transitory computer-readable medium storing instructions for improving auto-parking in a vehicle and that when executed by the one or more processors cause the one or more processors to:
in response to initiating auto-parking of the vehicle:
define a set of thresholds according to at least environmental characteristics of a surrounding environment of the vehicle;
monitor, while the vehicle is auto-parking, a vehicle state of the vehicle according to sensor data from at least one sensor of the vehicle, wherein the sensor data includes observations about the vehicle and the surrounding environment of the vehicle; and
selectively execute a response function according to whether the vehicle state satisfies at least one threshold in the set of thresholds, wherein the response function mitigates abnormalities encountered by the vehicle when auto-parking.

10. The non-transitory computer-readable medium of claim 9, wherein the instructions to selectively execute the response function include instructions to i) select the response function from a group of responses according to the at least one threshold that the vehicle state satisfies, and ii) execute the response function when the vehicle state satisfies the at least one threshold to control at least one vehicle system to adjust the vehicle state in relation to the surrounding environment.

11. The non-transitory computer-readable medium of claim 10, wherein the instructions to selectively execute the response function include instructions to control the vehicle to adjust a clearance distance between the vehicle and a defined boundary, and
wherein the defined boundary includes one or more of an obstacle, a marker of a roadway, and a marker of a parking space.

12. The non-transitory computer-readable medium of claim 9, wherein the instructions to define the set of thresholds include instructions to acquire the environmental characteristics of the surrounding environment to identify at least traffic congestion, roadway conditions, and contextual conditions, and
wherein the contextual conditions indicate attributes of at least a current location of the vehicle including aspects associated with a parking facility.

13. The non-transitory computer-readable medium of claim 9, wherein the instructions to define the set of thresholds includes instructions to adapt values for operating characteristics of the vehicle as a function of the environmental characteristics, and
wherein the instructions to acquire the environmental characteristics include instructions to collect the sensor data and analyzing the sensor data to produce the environmental characteristics in relation to the operating characteristics, and
wherein the operating characteristics include one or more of parking distances, operating distances, speeds, and acceptable vibrations.

14. A method of improving auto-parking in a vehicle, comprising:
in response to initiating auto-parking of the vehicle, defining a set of thresholds according to at least environmental characteristics of a surrounding environment of the vehicle;
monitoring, while the vehicle is auto-parking, a vehicle state of the vehicle according to sensor data from at least one sensor of the vehicle, wherein the sensor data includes observations about the vehicle and the surrounding environment of the vehicle; and
selectively executing a response function according to whether the vehicle state satisfies at least one threshold in the set of thresholds, wherein the response function mitigates abnormalities encountered by the vehicle when auto-parking.

15. The method of claim 14, wherein selectively executing the response function includes i) selecting the response function from a group of responses according to the at least one threshold that the vehicle state satisfies, and ii) executing the response function when the vehicle state satisfies the at least one threshold to control at least one vehicle system to adjust the vehicle state in relation to the surrounding environment.

16. The method of claim 15, wherein selectively executing the response function includes controlling the vehicle to adjust a clearance distance between the vehicle and a defined boundary, wherein the defined boundary includes one or more of an obstacle, a marker of a roadway, and a marker of a parking space.

17. The method of claim 14, wherein selectively executing the response function includes in response to determining the vehicle is parked, executing the response function by electronically communicating the vehicle state to an electronic device associated with an operator of the vehicle.

18. The method of claim 14, wherein defining the set of thresholds includes acquiring the environmental characteristics of the surrounding environment to identify at least traffic congestion, roadway conditions, and contextual conditions, and
wherein the contextual conditions indicate attributes of at least a current location of the vehicle including aspects associated with a parking facility.

19. The method of claim 18, wherein defining the set of thresholds includes adapting values for operating characteristics of the vehicle as a function of the environmental characteristics,
wherein acquiring the environmental characteristics includes collecting the sensor data and analyzing the sensor data to produce the environmental characteristics in relation to the operating characteristics, and
wherein the operating characteristics include one or more of parking distances, operating distances, speeds, and acceptable vibrations.

20. The method of claim 14, wherein updating the vehicle state includes analyzing the sensor data to determine values of operating characteristics that correspond with separate ones of the set of thresholds, wherein vehicle state defines the values of the operating characteristics for a current time,
wherein initiating auto-parking of the vehicle includes determining a command to begin auto-parking has been received by the vehicle, and
wherein executing auto-parking of the vehicle includes controlling the vehicle to autonomously navigate and park without intervention by an operator of the vehicle.
